(19) United States
(12) Patent Application Publication
(10) Pub. No.: US 2011/0121781 A1
(43) Pub. Date: May 26, 2011

(54) Scalable, modular and intelligent power system

(75) Inventors: Edmund David Burke, Santa Maria, CA (US); Jason Matthew Walsh, Santa Maria, CA (US)

(73) Assignee: Space Information Labs LLC., Santa Maria, CA (US)

(21) Appl. No.: 12/927,186

(22) Filed: Nov. 8, 2010

Related U.S. Application Data
(60) Provisional application No. 61/281,611, filed on Nov. 20, 2009.

(51) Int. Cl. H02J 7/00

(52) U.S. Cl. 320/110

(57) ABSTRACT

As an improvement to the architecture, utility, efficiency and cost associated with the procurement, setup, and operation of a power system for utilization in aerospace, military, commercial, consumer, educational and transportation platforms. A scalable, modular and intelligent power system (10) as illustrated in FIG. 1 consists of a power system (12), and a communications system (14). Power system (12) is comprised of a scalable array of ICP's (16) isolated from each other via schottky diodes (34), with the combined power out put of ICP1 through ICPx (16) resulting in a final power system output (36), with its corresponding power system ground (38). Communications system (14) is comprised of a communications processor (24) interfacing internally with each individual ICP1 through ICPx (16) via opto isolated I2C communication port (30), enabling bi-directional communications between power system (12) and the outside world via external communications portal (26).

### CROSS-REFERENCE TO RELATED APPLICATIONS

This application is the formal patent submission based upon the Provisional Patent No. 61/281,611 titled, “Scalable, Modular and Intelligent Power System” issued on 20 Nov. 2009.

### BACKGROUND

### Prior Art

The following is a tabulation of some prior art that presently appears relevant:

| Pat. No. | Kind Code | Issue Date | Patentee |
|---|---|---|---|
| 5,534,366 | B1 | 1996-07-09 | Hwang et. al. |
| 6,043,629 | B1 | 2003-03-28 | Ashley et. al. |

Current high-tech and aerospace power applications typically utilize older rechargeable battery technologies such as silver zinc, nickel-cadmium, nickel metal hydride and lead acid to power their missions. Batteries built using these technologies are routinely heavy and subject to expensive qualification testing in order to ensure their mission readiness. They provide no real-time health status feedback or protection and they are not modular in design.

To the best of our knowledge, there is no existing prior art regarding a scalable, modular and intelligent power system as described therein by this patent. There are however, a limited number of inventions addressing modular battery packs and modular control electronics for batteries. A modular battery pack invention by Hwang et al. only concerns itself with physical mounting interfaces for battery modularity for easy replacement. The modular control electronics for batteries invention by Ashley et al. only concerns itself with the modular control of charging each battery cell to protect the batteries and optimize their performance. Due to the nature of these inventions, neither of them can be adapted to the intent and demands that are required by this invention for the following reasons:

(a) There is no system or method available to provide real-time monitoring/feedback of multiple arrays of batteries for determining their individual cell voltages and temperatures.
(b) Rapid battery conditioning and cell balancing is not possible within the confines of either of these prior art inventions, nor is it available at all within the industry.
(c) No capability exists for real-time data gathering from multiple cells comprising a battery.
(d) It is not possible to automatically protect any battery system from over charge, under voltage and short circuit on an individual cell basis, especially if the battery size is in a large and complex matrix expansion.
(e) No fail-over/safe system exists to ensure functionality if a single cell fails within a battery.
(f) All present battery designs negate the possibility of configuration into a modular ‘Lego’ system, either in a physical arrangement or electrical one, thus increasing design, implementation and qualification costs.
(g) The limiting design of existing systems precludes the rapid integration of an external synergistic parallel power source to augment and dramatically increase power output.
(h) Present battery design configurations are limited to their individual unique manufacture, and do not allow for their rapid reconfiguration to a larger/smaller capacity, either physically or electronically.
(i) Existing battery systems do not incorporate methodology for isolating/combining battery strings via software command in the event that mission requirements change real-time, or if a battery has an internal failure.
(j) All of today's battery systems for aerospace use are based upon obsolete technology, and are size/weight excessive in addition to being very inefficient by not protecting against a series battery cell failure and will completely fail if a single battery cell fails.
(k) In addition to power density problems that accompany the limiting factors encountered in fielding today's old battery technology, this old technology suffers from significant operations and maintenance issues and costs to recondition and service the batteries.
(l) Thermal packaging issues presently plague all aerospace battery designs, with no cost effective way to circumvent them.
(m) Launch environments are presently extreme to standard battery systems that are flown, and cause labor intensive and costly pre-qualification testing methods to be employed to mitigate potential problems from surfacing in the operational employment of the full system.
(n) Size and weight issues constantly arise during employment of existing battery systems, resulting in the sacrifice of other mission capabilities.
(o) Current aerospace application battery systems are limited by the arrangement of cells to develop a particular battery voltage and capacity, and are not able to be quickly reconfigured in the event of a change in mission rules or application requiring a change in voltage or current capacity.
(p) Deployed aerospace battery systems today are incapable of providing instantaneous in depth real-time health monitoring, thus precluding the capability to head-off a battery cell failure before it happens.
(q) Today's battery systems do not accommodate the capability for predictive performance in accordance with the number of cycles it has been subject to.
(r) Present battery architectures do not allow for a larger method of control aside from the immediate system they are employed within, thus eliminating the possibility of mesh network control and redundant switching.

### SUMMARY

All of these complexities and shortcomings possibly explain and justify why the science, application and benefits of a modular, scalable and stackable intelligent battery system is unheard of within the battery or power system industry. It is clearly evident that thus far in human history, the benefits of utilizing a modular, scalable and stackable intelligent battery system for small consumer applications, all the way up to complex aerospace or other applications is non-existent.

### ADVANTAGES

Accordingly, the main objects and advantages of this invention are that it be smartly designed and fielded to safely, efficiently and inexpensively perform the function of a portable power source which is scalable, modular and stackable to meet any mission requirement, and be reconfigured at any time to meet evolving mission criteria.

With this approach, new industries can be developed which utilize this technology for solving any number of previously unsolvable system applications from aerospace, transportation, first responders, portable power and operations in delicate environments where dense power sources are required without any noise or toxic fumes/harmful by-products being released into the general vicinity of operations.

In addition to these clear advantages of our interpretation of the most practical form a scalable, modular and stackable intelligent power system should take the form of, this invention also benefits from the following important advantages:

(a) The modular scalability allows for building any configuration of power system with corresponding control software also being modular and scalable for instant interfacing with hardware, allowing for ease of monitoring individual battery cell voltages and temperatures.

(b) The simplicity and elegance of the scalable, modular and stackable intelligent power system allows instant access to the capability of conditioning and balancing the individual battery cells prior to full system power-up.

(c) For the first time in battery history, it will be possible to gather real-time data on the performance of the individual cells that comprise a battery, and subsequently utilize that data for real-time monitoring and historical health analysis to find a weak battery cell prior to failure within the system.

(d) Risk mitigation on battery/power system operation is controlled internally within the power system through protection from over charge, under voltage and short circuit on an individual cell basis, irrespective of the size of the final power system configuration.

(e) Internal battery cell redundancy is attained through the ability to remove the debilitating effects of a single cell failure within the battery system to ensure the capability of the Intelligent Power System to provide full power to complete the pre-defined mission.

(f) The main strength of this invention is that at its core, the primal capability exists for matrix-like scalability of the battery system rapidly and simultaneously in hardware/firmware/software to meet practically any system requirements that a user may define for their defined operations.

(g) This invention has an open architecture that can easily accommodate a synergistic interface with external power systems such as solar panels/fuel cells for charging and providing a new state of the art efficiency and dense power system for special new applications, including battery charging via direct, indirect or inductive methods.

(h) Customer needs are easily met on a rapid and efficient basis through the matrix like assembly of all the pre-defined components which makeup the intelligent power system which are scalable/modular in both hardware and software, with all interfaces being mirror-like repeatable and expandable with practically no limit.

(i) All possible fail-over/fail safe capabilities are integrated into the intelligent power system, and will allow for redundancy and phase-over to a backup state of operation to insure mission success.

(j) Cost efficiency in combination with ultimate reliability are the guidelines of the intelligent power system design and operation, allowing for a revolutionary application in missiles, rockets, satellites, unmanned aerial vehicles and other weight/size constrained systems which can greatly benefit from a dense power supply in a fraction of the previous size/weight/volume the industry has reluctantly accepted until this time.

(k) The intelligent power system and any associate interfacing system such as a fuel cell or solar panel greatly benefit from the almost non-existent operational maintenance which other power systems continually require.

(l) The extremely safe and environmentally tolerant operational nature of the intelligent power system allows for its utilization in practically any scenario that a user could conceive of in extreme temperatures, and if the environment is of an extreme cold, extremely thin strip heaters can be layered between battery cells and powered by the cell itself with ample power margin remaining for completing the mission.

(m) A simple load test can be implemented on a battery system prior to use with individual cell monitoring providing the needed confidence that the battery system is ready for use, and in combination with this, no additional environmental is required due to the shock and vibration immunity of the entire system, in direct contrast to all other battery power systems supporting aerospace programs.

(n) The scalability and modularity of the intelligent power system allows for its use in an array of military, commercial and industrial applications requiring a very small mechanical footprint where size and weight are always an issue.

(o) If last minute mission needs change, the matrix design capability of the intelligent power system in both hardware and software allows for rapid reconfiguration in its complex surrounding environment to accommodate any contingency of the system it is powering.

(p) The simple yet elegant nature of the intelligent power systems stems from its capability for real-time computer monitoring via a graphic user display, so it can be determined if a rare unexpected battery cell failure is imminent, allowing for the monitoring of the actual internal reconfiguration of the battery as it is happening.

(q) Massive amounts of data already resident in a lithium polymer battery database can be referenced against an intelligent power system's real-time performance for predictive modeling in the event that a particular battery/cell has been subject to many recharging cycles, and credibly assessed with respect to its probability of failure during that actual cell's performance time being monitored.

(r) In advanced applications, it is entirely possible to employ a single or many intelligent power systems, hybrid or not, within a mesh network's control, whereby the performance of these individual unit power systems can be automatically controlled/reconfigured upon demand for meeting any changing power needs as they occur.

### DRAWINGS

### Figures

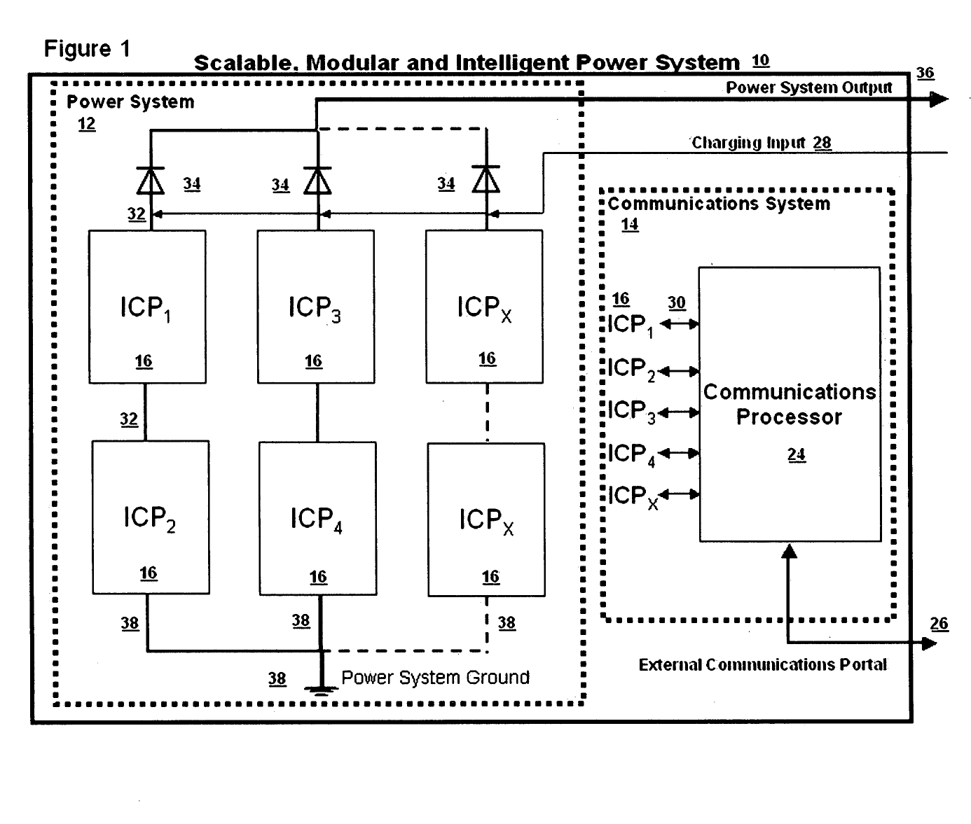

FIG. 1 is a functional external block diagram depicting the delineation of major system responsibilities within the Intelligent Cell Pack (ICP) of the scalable, modular and intelligent power system.

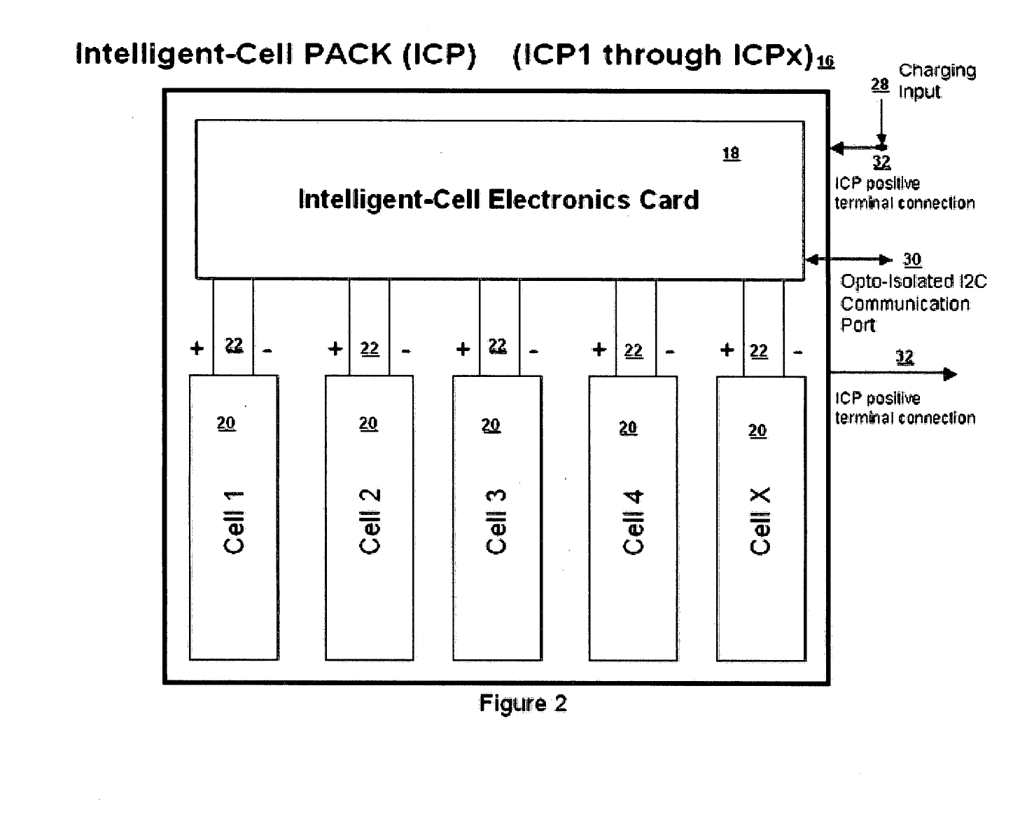

FIG. 2 is a block diagram of the entire interactive architecture of the scalable, modular and intelligent power system's major components.

### REFERENCE NUMERALS

10 scalable, modular and intelligent power system
12 power system
14 communications system
16 ICP1 through ICPx
18 intelligent-cell electronics card
20 cells 1 through cell X
22 cells 1 through cell X output connection
24 communications processor
26 external communications portal
28 charging input
30 opto isolated I2C communication port
32 ICP positive terminal connection
34 schottky diode
36 power system output
38 power system ground

### DETAILED DESCRIPTION

### FIGS. 1 and 2

A scalable, modular and intelligent power system 10 as illustrated in FIG. 1 consists of a power system 12, and a communications system 14. Power system 12 is comprised of a scalable ICP array of ICP1 through ICPx 16 isolated from each other via schottky diodes 34, with the combined power out put of ICP1 through ICPx 16 resulting in a final power system output 36, with its corresponding power system ground 38.

As illustrated in FIG. 2, a charging input 28 directly, indirectly or inductively recharges cells 1 through cell X 20 contained within ICP1 through ICPx 16 via ICP positive terminal connection 32. ICP1 through ICPx 16, each being comprised of an intelligent-cell electronics card 18 and a scalable array of cells 1 through cell X 20. Cells 1 through cell X 20 interface with intelligent-cell electronics card 18 via cells 1 through cell X output connection 22. Individual ICP1 through ICPx 16 cumulatively provide output power at ICP positive terminal connection 32.

In FIG. 1, communications system 14 is comprised of a communications processor 24 interfacing internally with each individual ICP1 through ICPx 16 via opto isolated I2C communication port 30, enabling bi-directional communications between power system 12 and the outside world via external communications portal 26.

FIGS. 1 and 2 together describe the complete scalable, modular and intelligent power system 10 from the cell component level of cells 1 through cell X 20, in-turn through the ICP1 through ICPx 16 level, and subsequently showing how ICP1 through ICPx 16 forms the building block of power system 12. Also illustrated in FIGS. 1 and 2 is how communications system 14 interfaces with power system 12, and subsequently provides the power system output 36 in combination with demonstrating the ability of how communications with power system 12 occur, to form the complete scalable, modular and intelligent power system 10.

### Operation—FIGS. 1-2

Scalable, modular and intelligent power system 10 as illustrated in FIG. 1 and FIG. 2. is an integrated consortium of functional hardware, firmware and software responsibilities interacting to form a single whole system. Within this scalable, modular and intelligent power system 10, the power system 12 and communications system 14 seamlessly interact with each other to produce a highly stable and reliable dense electrical energy source measurable between power system output 36 and power system ground 38 terminals.

Command and control of the power system 12 is achieved via the communications processor 24 of communications system 14. The main capabilities of the communications processor 24 include the ability to monitor and transmit voltage, current and temperature of cells 1 through cell X 20 via cells 1 through cell X output connection 22 in addition to providing full battery conditioning and cell balancing of cells 1 through cell X 20 within ICP1 through ICPx 16 and also provide automatic over charge, under voltage and short circuit protection of the entire configuration. Opto isolated I2C communication port 30 interfaces with intelligent-cell electronics card 18, with ICP1 through ICPx 16 being independent and isolated from each other via schottky diode 34. A redundant structure of cells 1 through cell X 20 is also employed in the event of a catastrophic failure of any one cell. Charging input 28 directly, indirectly or inductively charges cells 1 through cell X 20 contained within ICP1 through ICPx 16 via ICP positive terminal connection 32. External communications portal 26 accommodates practically every type of flexible communications standard available, including but not limited to RS-422, RS-232, 1553, USB and I2C. Communications processor 24 also internally utilizes an intelli-com optoisolated internal I2C bus input interfacing with intelligent-cell electronics card 18 via opto isolated I2C communication port 30.

Intelligent-cell electronics card 18 utilizes but is not limited to an industry standard opto-isolated I2C communication capability and embedded software enabling automatic over charge, under voltage and short circuit protection for cells 1 through cell X 20 internal to ICP1 through ICPx 16.

### Advantages

From the description above, a number of advantages of the following qualities are exhibited by the components that comprise this highly adaptive, scalable, stackable and modular system:

1) The incorporation of a unique scalable, modular data architecture that provides real-time monitoring and feedback of the battery's individual cell voltages, temperatures and current.

2) Implementation full battery conditioning and cell-balancing.

3) Real-time data from the battery health and status condition is provided for data collection and storage.

4) Special built in circuitry providing automatic over charge, under voltage, and short circuit protection of the battery.

5) A redundant cell structure is also employed to ensure functionality in the event of a catastrophic failure of any one cell.

6) The overall system approach to this invention is to be of a modular Lego battery structure that can be rapidly and flexibly configured/reconfigured for multiple operational requirements, resulting in a drastic reduction of qualification costs due to the commonality of the scalable, modular hardware, firmware and software.

7) A hybrid combination of the battery and an external recharging power source such as a fuel cell or solar panel system makes it possible to quickly recharge the battery system, resulting in a sustainable, power-dense capability.

8) The entire intelligent power system is comprised of modular, stackable and scalable power sources, allowing any desired configuration to be efficiently assembled without additional engineering.

9) The system utilizes redundant and electrically isolated parallel battery strings for graceful power reduction in case of a cell failure.

10) The small physical operating envelope of the intelligent power system allows for its use internally/externally with avionic systems, and broad use in aerospace applications such as satellites, rockets, missiles, unmanned aerial vehicles, reusable launch vehicles, etc.

11) A significant reduction in operations/maintenance costs to approximately one tenth of previous battery systems occur with this improved battery energy density, which is two to three times that compared to other aerospace rechargeable batteries currently being used such as silver zinc, nickel cadmium, nickel metal hydride and lead acid.

12) In harshly cold environments, ultra thin strip heaters can be inserted inbetween individual cells to provide individual heating with thermal control, with no impact to overall battery dimension.

13) The entire intelligent power system is essentially shock and vibration immune, enabling its use in practically every aerospace vehicle in every launch/on-orbit harsh environment.

14) The system is adaptable to fit practically any mechanical footprint for broad use in military and industrial applications.

15) The modular and scalable bus architecture for battery cells is independent of order series/parallel arrangement, or voltage.

16) All battery cells are uniquely addressable, and can communicate simultaneous health and status in real-time for immediate battery evaluation and automatic shutdown in case of an individual battery cell failure.

17) A computer display allows for battery performance monitoring, data collection and storage, including data on battery cell voltages, temperature, current, state of charge and overall charge/discharge cycle parameters, all critical data for a safety evaluation.

18) The entire battery system can be reconfigured based on mesh network topologies and redundant switching.

### CONCLUSION, RAMIFICATIONS AND SCOPE

Accordingly, the reader will see that the type of power system defined by this invention is the embodiment of virtues that serve to make the scalable, modular and intelligent power system a worthwhile and inexpensive proposition for all users small and large. With the advent of the scalable, modular and intelligent power system into the marketplace, commercial, military, educational and all other users will no longer be consumed, as well as discouraged, by the inefficient and rudimentary nature of the power system options available prior to this invention. Additionally with this invention, these recent energy dense power technologies can further be used in a hybrid combination with other advanced technologies such as a solar panel array, or small portable fuel cell system to synergistically produce phenomenal miniature power sources in very small spaces unheard of in today's operational environment. In this hybrid configuration, an array of industries can greatly expand their present envelope of operations with this new compact and energy-dense power source.

Additionally, with this invention, any user will have a simple, coherent, instant and extremely usable system for integrating the substantial benefits of a scalable, modular and intelligent power system into their mission requirements and profile. Furthermore, the scalable, modular and intelligent power system has the additional advantages in that: it permits a user to have great insight into the internal workings of their employed version of the scalable, modular and intelligent power system.
it enables the long-term stability benefits afforded through conditioning and balancing of individual battery cells which prolongs their life.
it makes possible for the first time, the ability to gather real-time data on the performance of the battery down to the cell level.
it offers the battery protection from catastrophic circumstances arising due to over voltage charge, under voltage and short circuit.
it affords flexibility in battery operation through redundancy and fail-over/fail-safe functionality.
it leverages the lego/matrix-like scalability in hardware/software to provide any size and configuration battery that a user might require.
it is easily combinable with other parallel synergistic power systems such as solar panels or fuel cells to create an entirely new hybrid power system entity still based upon the scalability modularity and intelligence of its building block matrix style design in hardware and software.
it is capable of instantly being reconfigured into a larger or smaller system based upon a customer's changing needs, with no limits in either direction.
it is instantly and intelligently capable of reconfiguring itself real-time during any mission phase to insure mission success in the event of any changing system parameters of hardware receiving power from it.
it provides the most cost effective means for powering practically any type of aerospace or other system by providing the densest power system possible in the smallest amount of space.
it offers the most maintenance-free power capability to have ever been invented, and its simplicity of operation powers anything at least 2 or 3 times longer than the best capability available today.
it functions in the harshest temperature environments ever encountered by aerospace vehicles, with considerable margin left over available to meet any mission requirements.
it shock and vibration tolerance under practically any circumstances is unmatched by any other power system.
it is usable in practically any space where heating/venting may have been an issue with previous battery systems.
it has a matrix design which doesn't restrict the arrangement of internal battery cells to provide the desired energy output.
it includes a real-time computer monitoring capability displaying health and status for each individual cell in addition to the overall battery system health.
it comes from a long heritage of battery reliability with roots in the consumer electronics environment, and as a building block of this invention, it affords the underlying power capability necessary for use in expensive delicate aerospace and other systems.
it is capable of being arranged into a large network where many systems exist, and can be operated automatically by a master controller based upon mesh network topologies.

Although the description above contains many specifications, these should not be construed as limiting the scope of the invention, but merely providing illustrations of the presently preferred embodiment of this invention. For example, the ICPs themselves do not necessarily need to be powered by batteries, or a combination of batteries with another source in a hybrid configuration, but also by any technology such as solar cells, fuel cells, nuclear sources, or even a form of energy not yet discovered. The essence of this invention is the scalability, modularity and stackability in hardware, firmware and software to produce an integrated intelligent power system in a ‘lego’ type fashion, and utilizing any energy source in this system to provide portable or fixed location on demand power under any circumstances. Thus, the scope of this invention should be determined by the appended claims and their legal equivalents.

We claim:

1. A completely scalable, modular and intelligent power system comprised of a chemistry independent power system interfacing with a communications system, said chemistry independent power system and said communications system being mirror like repeatable in a functional matrix structure which is expandable with no limit and maintaining standardized interconnect junction points between all interfaces, said scalable, modular and intelligent power system being compatible with an external power supply means and a charging means which is combinable in any manner of arrangement.

2. A power system of claim 1 wherein said power system is arranged into a mechanical footprint whereby energy density is maximized.

3. A power system of claim 2 wherein overall functionality and capability of said power system provides monitoring and reconfiguration of itself in any manner in the event of any internal modular power failure within said power system, allowing for instant stabilization to maintain the required uninterrupted power output.

4. A power system of claim 3 wherein said communications system controls and monitors said power source, said communications system being independent of said power source internal component ordering and connection method, said communications system utilizing a unique addressable means to identify and communicate with said power source for health and status monitoring of said power source internal components.

5. A power system of claim 4 which can be arranged in any hybrid method with an external power source.
